(19) United States
(12) Patent Application Publication
(10) Pub. No.: US 2006/0117919 A1
(43) Pub. Date: Jun. 8, 2006

(54) Method and apparatus for manufacturing contact lenses

(76) Inventor: Hank Stute, Queen Creek, AZ (US)

Correspondence Address: SNELL & WILMER;ONE ARIZONA CENTER, 400 EAST VAN BUREN, PHOENIX, AZ, 850040001, US

(21) Appl. No.: 11/005,493

(22) Filed: Dec. 6, 2004

(51) Int. Cl. B23B 5/00

(52) U.S. Cl. 82/165

(57) ABSTRACT

The present invention is directed towards a lens button fixture for use in a lens machining tool such as a lathe. In accordance with various exemplary embodiments of the present invention, the fixture has a base with a lens retaining end for holding a contact lens button and a fixture positioning mechanism for locating the lens button fixture in substantially the same location on the lens machining tool upon removal and replacement of the lens button fixture.

### CROSS-REFERENCE TO RELATED APPLICATIONS

This application claims priority to U.S. patent application Ser. No. ______ entitled “METHOD AND APPARATUS FOR MANUFACTURING CONTACT LENSES” filed Dec. 3, 2004 and is incorporated herein by reference.

### FIELD OF INVENTION

This invention relates generally to the manufacture of contact lenses, and more particularly, to apparatus used in the manufacture of contact lenses.

### BACKGROUND OF THE INVENTION

Various methods of manufacturing contact lenses exist, for example, by lathing a lens from a disk (or button) of lens material. Typically, the button is mounted in a lathe collet and a back surface (corneal contacting) radius is formed. Subsequently, the button is then mounted, by various means now known or as yet unknown in the art, on a rounded end of a lens fixture, the end having a radius generally corresponding to that of the back surface radius of the button. The front surface of the lens is then formed with the desired shape of the lens. Additionally, various intermediate lathing operations, for example, cutting an edge chamfer in the button, cutting the lens to a desired thickness, and/or polishing the lens may also be performed.

Often, depending on the type of lathing or polishing operations performed on the lens, the lens fixture may need to be removed from the lathe one or more times prior to finishing the lens. Such mounting and removal of the lens fixture from lathe generally require subsequent readjustment of the lens button and/or fixture within the lathe in order to ensure proper forming of the lens in subsequent operations to, for example, maintain the proper alignment between the base curve block and the front curve block.

Accordingly, a lens fixture positioning mechanism which assists in accurate placement of the lens fixture when removed and replaced into a lathe is desirable.

### SUMMARY OF THE INVENTION

While the way in which the present invention addresses the disadvantages of the prior art will be discussed in greater detail below, in general, briefly, the present invention is directed towards a lens button fixture for use in a lens machining tool such as a lathe. In accordance with various exemplary embodiments of the present invention, the fixture has a base with a lens retaining end for holding a contact lens button and a fixture positioning mechanism for locating the lens button fixture in substantially the same location on the lens machining tool upon removal and replacement of the lens button fixture. Additional advantages may also become apparent such as the ability to reduce the mass of fixture and/or the reduction of shifts in the fixtures center of gravity, which may lead to vibration and other effects.

### BRIEF DESCRIPTION OF THE DRAWINGS

Additional aspects of the present invention should become evident upon reviewing the non-limiting embodiments described in the specification taken in conjunction with the accompanying figures, wherein like numerals designate like elements, and:

FIG. 1 is a side view of a contact lens manufacturing device, collet, contact lens fixture, contact lens positioning mechanism, contact lens button and contact lens manufacturing tool in accordance with an exemplary embodiment of the present invention; and

FIGS. 2(a)-(d) are side views of an exemplary embodiments of the present invention, exploded and assembled, comprising a collet, lens fixture, snap-ring and groove lens fixture positioning mechanism, lens button and tool.

### DETAILED DESCRIPTION

The following descriptions are of exemplary embodiments of the invention only, and are not intended to limit the scope, applicability or configuration of the invention in anyway. Rather, the following description is intended to provide convenient illustration for implementing various embodiments of the invention. As will become apparent, various changes may be made in the function and arrangement of the elements described herein without departing from the spirit and scope of the invention. For example, though not specifically described, various manufacturing operations may be performed on a contact lens button and should be understood to fall within the scope of the present invention. Similarly, though generally described herein with respect to lathing operation, as noted below, numerous other devices for machining contact lens may also benefit and fall within the scope of the present invention.

Briefly, various lathes are known in the art and are used to manufacture a lens from a disk (or button) of lens material (known or as yet unknown materials) by turning the button and removing and/or shaping the lens material. Lathes are relatively common devices used to turn lens buttons to shape them. However, various other lens shaping devices might also be used in the manufacture of contact lenses and likewise fall within the of the present invention. Nonetheless, the present invention is described herein in the context of lathing devices, though the invention should not be construed as so limited.

In the context of a lathe, in accordance with one embodiment of the present invention, the button is mounted on a lens button fixture, and the fixture is inserted into a lathe collet. The lathe collet rotates and a lens machining tool is used to shape the button. A lens button fixture for use in a lens machining tool used in the manufacture of contact lenses comprises a fixture positioning mechanism for locating the lens button fixture in substantially the same location on the lens machining tool upon removal and replacement.

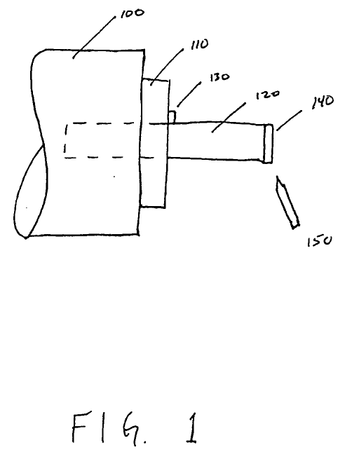

For example, in an exemplary embodiment of the present invention and with reference to FIG. 1, a typical lens manufacturing operation in accordance with the present invention comprises tooling including a lathe 100 (or other lens manufacturing device), a collet 110, lens button fixture 120, fixture positioning mechanism 130, lens button 140 and a lens shaping tool 150.

In this exemplary embodiment, collet 110 is a mechanism for securing fixture 120 in a manner which facilitates removal and replacement of fixture 120. In this embodiment, in the context of a lathe, lathe 100 rotates button 140 by translating rotation of collet 110 to fixture 120 and thus, to button 140. As such, collet 110 and fixture 120 are preferably cylindrical members, substantially centered at the rotation center of lathe 100, though one skilled in the art will appreciate that any number of shapes and configurations of the components of the present invention may likewise be used to facilitate rotation of button 140.

With continued reference to FIG. 1, collet 110 suitably provides the ability to center fixture 120 with respect to lathing operations. Additionally, in accordance with various embodiments of the present invention, collet 110 suitably provides “quick-release” abilities for fixture 120. For example, in the presently described embodiments, collect 110 has a cylindrical aperture which receives substantially similarly shaped fixture 120. In this embodiment, collet 110 is suitably configured with a locking mechanism (e.g., a set screw) which is tightened on fixture 120.

Alternatively, collet 110 may be provided with a centered, tapered aperture and fixture 120 has a tapered shape which substantially conforms to collet 110. Thus, when fixture 120 is placed within the aperture of collet 110, fixture is suitably secured enough to facilitate rotation of button 140, but not so secure as to create difficulties in removing fixture 120.

It should be understood however, that in various alternative embodiments, collet 110 may take various other configurations which facilitate translating rotation of lathe 100 to fixture 120 and thus, to button 140. For example, collet 110 may comprise a mechanism such as a “chuck” (e.g., 3 or 4 jaw chuck), which suitably secures fixture 120. Alternatively, collet 110 may be suitably omitted from embodiments of the present invention. For example, fixture 120 may be secured directly to lathe 100. In such embodiments, upon rotation of lathe 100, rotational energy is translated directly to fixture 120 (and button 140) from lathe 100.

With continuing reference to FIG. 1, fixture 120 suitably provides or cooperates with a mechanism for mounting button 140 during shaping, manufacturing and/or forming operations. In various embodiments of the present invention, lens shaping tool 150 generally comprises any tool, known or as yet unknown, used for shaping, cutting, forming, polishing or otherwise manufacturing contact lenses. For example, as noted above, in various exemplary lens manufacturing operations, a back surface (corneal contacting) radius is formed in button 140. Subsequently, button 140, now having a curved back surface, is then mounted, by various means now known or as yet unknown in the art, such as using adhesives such as various soluble waxes on the end of lens fixture 120. Upon securing button 140 to fixture 120, various operations may be performed on the front surface and sides of the button 140 to create a desired shape of the lens (e.g., base curve or the like). Similarly, any number of various intermediate operations, for example, cutting an edge chamfer in the button 140, cutting button 140 to a desired thickness, and/or polishing button 140 may also be performed.

As noted above, fixture 120 may be repeatedly removed and/or replaced during and in between operations performed on button 140. In accordance with various embodiments of the present invention, fixture 120 comprises a positioning mechanism 130 which suitably provides the ability to replace fixture 120 in collet 110 (or other portion of lathe 100 or other lens manufacturing tool) in substantially the same location.

For example, in accordance with an exemplary embodiment of the present invention, positioning mechanism 130 comprises a raised portion on an outer surface of fixture 120, which prevents fixture 120 from being further inserted into collet 110. As such, when fixture 120 is removed from collet 110 and subsequently reinserted, fixture 120 stops at the same position as when previously inserted.

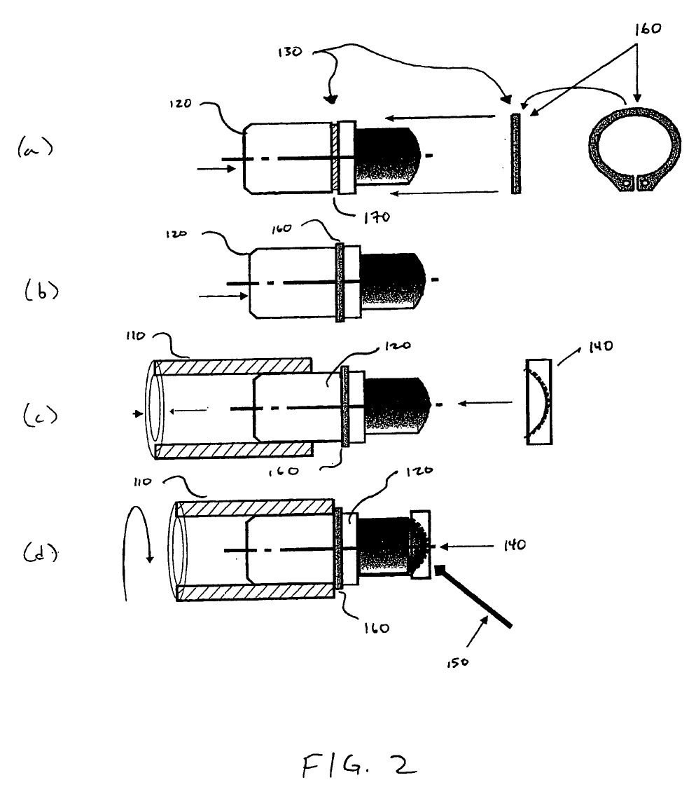

With reference to FIGS. 2(a)-(d), in accordance with an exemplary embodiment of the present invention, positioning mechanism 140 comprises an axial ring which encircles fixture 120. The axial ring is suitably secured, preferably releasably, to fixture 120 in a manner which prevents the ring from moving laterally along fixture 120.

In accordance with various embodiments of the present invention, fixture positioning mechanism 130 is adjustable to variably set the position of fixture 120. For example, in the context of an axial ring embodiment, the axial ring may slide along the length of fixture 120 until suitably secured. Securing of axial ring is suitably accomplished by any mechanism which prevents ring from sliding along fixture 120. For example, set screws, clamps and similar mechanisms capable of which tighten positioning mechanism 130 to fixture 120 may be used in accordance with the various embodiments of the present invention. Alternatively, in accordance with another embodiment of the present invention and with specific reference to FIGS. 2(a)-(d), positioning mechanism 140 comprises a snap-ring 160 and groove 170 configuration, wherein snap-ring 160 seats in groove 170, thus preventing movement of positioning mechanism 140 and, accordingly, fixture 120, upon removal and reinsertion into lathe/collet 100/120.

Lastly, various aspects of the invention have been described in illustrative embodiments. Of course, many combinations and modifications of the above-described structures, arrangements, proportions, elements, materials and components, used in the practice of the invention, in addition to those not specifically described, may be varied and particularly adapted to specific environments and operating requirements without departing from those principles.

I claim:

1. A lens button fixture for use in a lens machining tool used in the manufacture of contact lenses, comprising:
a base having a lens retaining end; and
a fixture positioning mechanism for locating the lens button fixture in substantially the same location on the lens machining tool upon removal and replacement.

2. The lens button fixture in accordance with claim 1, wherein said base is inserted in to the lens machining tool and wherein said fixture positioning mechanism comprises a stop which prevents said base positions said lens fixture at a pre-determined location.

3. The lens button fixture in accordance with claim 2, wherein said stop is an axial ring.

4. The lens button fixture in accordance with claim 3, wherein said ring is releasably secured to said base.

5. The lens button fixture in accordance with claim 2, wherein said stop is a snap ring.

6. The lens button fixture in accordance with claim 5, wherein said base further comprises a groove, said snap ring seating into said groove.

7. The lens button fixture in accordance with claim 1, wherein said fixture positioning mechanism is adjustable to variably set the position of the lens button fixture.

8. A lens button fixture used in the manufacture of contact lenses, comprising an elongated cylindrical base having a lens retaining end and an axial groove and a snap ring connected to said groove.
